(19) United States
(12) Patent Application Publication
(10) Pub. No.: US 2012/0101863 A1
(43) Pub. Date: Apr. 26, 2012

(54) MACHINE-MANAGEMENT SYSTEM

(76) Inventors: Byron Edwin Truax, Dunlap, IL (US); Rick Thomas Lasko, Homer Glen, IL (US); Jason Edward Carter, Morton, IL (US); Conrad Gene Grembowicz, Peorie, IL (US); Thomas Neil Brooks, JR., Oakley, IL (US); Christopher John Beckman, Forsyth, IL (US); Christopher Michael Sprock, Peoria, IL (US); Lonny Eric Johnson, Peoria, IL (US)

(21) Appl. No.: 12/910,543

(22) Filed: Oct. 22, 2010

(51) Int. Cl. G06F 19/00; G06Q 10/00

(52) U.S. Cl. 705/7.12; 701/34.4

(57) ABSTRACT

A method is disclosed for using information related to the service history of a power-train component. The method may include using a machine-management system with at least one information processor to acquire information related to loads experienced by the power-train component during a first period, the first period occurring before a disassembly procedure involving disassembly of the power-train component from a power train. The method may also include employing the machine-management system and the acquired information related to loads experienced by the power-train component during the first period to perform one or more tasks in connection with use of the power-train component after the disassembly procedure.

### TECHNICAL FIELD

The present disclosure relates to machines with power trains and, more particularly, to systems for acquiring and using information related to the loads applied to a component of a power train.

### BACKGROUND

Many machines include a power train for transmitting power mechanically to perform various tasks. For example, mobile machines often include a power train for propelling them. Additionally, mobile machines and stationary machines often include power trains for performing various other tasks, including, but not limited to, driving pumps, compressors, electric generators, and the like.

In transmitting power to perform such tasks, the components of a power train experience loads that tend to fatigue the components. Over time, these fatigue loads can decrease the strength of the components. Eventually, a component may fail because of the accumulated fatigue experienced in transmitting power. Absent provisions for monitoring the loads experienced by a power-train component, an operator, owner, or maintainer of a machine with a power train may have limited ability to know how much service life the power-train component may have left before it fails. This may compromise the ability to plan efficient and effective use of and maintenance of the machine and power train.

U.S. Pat. No. 6,434,512 B1 to Discenzo (“the '512 patent”) discusses a “machinery data collection and analysis system” for “obtaining and using data for machinery diagnosis and failure prediction.” The '512 patent discloses gathering information related to the “health” of a machine using various sensors, including using a torque sensor to monitor drive-train components. Based on the gathered information, the system disclosed by the '512 patent determines the “health” of various subsystems of the machinery and provides information to a user regarding any recommended maintenance procedures.

Although the '512 patent discloses monitoring various aspects of the operation of machinery and estimating the “health” of various subsystems of the machinery, certain disadvantages may persist. For example, the '512 patent only discloses provisions for estimating the health of the subsystems of the machinery while they remain assembled to the machinery. In many cases, it may be desirable to disassemble a power-train component from such machinery for various reasons and then reuse the component. For instance, after an initial period of service in a power train, a power-train component may be disassembled from the power train of a machine and subsequently reassembled to the same power train or assembled to another power train as part of a rebuilding or repair process. In such a circumstance, the loads applied to the power-train component during its initial period of service may affect its useful service life after it is disassembled from the power train and then reassembled to the same or another power train. The '512 patent fails to recognize this issue or suggest any provisions to address it.

The machine-management system and methods of the present disclosure solve one or more of the problems set forth above.

### SUMMARY OF THE INVENTION

One disclosed embodiment relates to a method of using information related to the service history of a power-train component. The method may include using a machine-management system with at least one information processor to acquire information related to loads experienced by the power-train component during a first period, the first period occurring before a disassembly procedure involving disassembly of the power-train component from a power train. The method may also include employing the machine-management system and the acquired information related to loads experienced by the power-train component during the first period to perform one or more tasks in connection with use of the power-train component after the disassembly procedure.

Another embodiment relates to a machine-management system. The machine-management system may include a machine having a power train, including a power-train component that was assembled to the power train in a service procedure after the power-train component had been used during a prior period. The machine-management system may also include at least one information processor that performs one or more machine-management tasks based at least in part on information related to loads experienced by the power-train component before its assembly to the power train in the service procedure.

A further disclosed embodiment relates to a method of operating a mobile machine. The method may include transmitting torque through a power train to propel the mobile machine, including transmitting torque through a power-train component that was assembled to the power train during a service procedure after having been used to transmit torque during a prior period. The method may also include sensing a magnitude of the torque transmitted through the power-train component subsequent to the service procedure. Additionally, the method may include estimating a remaining service life of the power-train component based on the sensed value of the torque transmitted through the power-train component subsequent to the service procedure in combination with information related to torque loads transmitted through the power-train component prior to the installation of the power-train component to the power train in the service procedure.

### BRIEF DESCRIPTION OF THE DRAWINGS

FIG. 1 shows one embodiment of a machine-management system according to the present disclosure.

### DETAILED DESCRIPTION

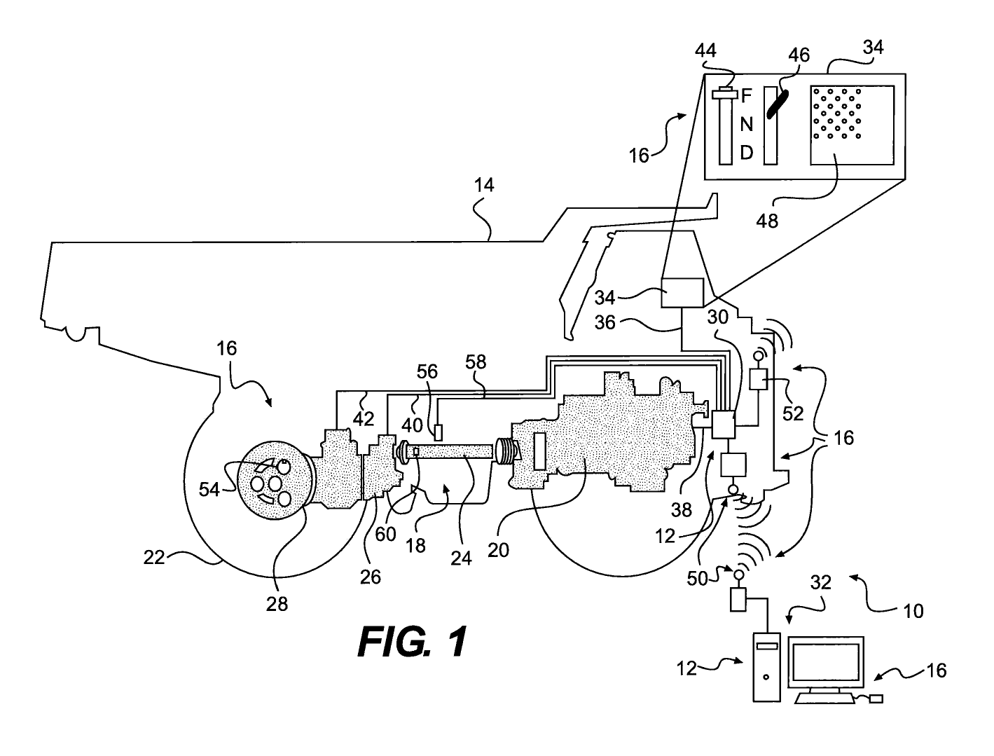

FIG. 1 illustrates one embodiment of a machine-management system 10 according to the present disclosure. Machine-management system 10 may include one or more information processors 12 for managing one or more machines, such as a machine 14. Machine-management system 10 may also include various inputs 16 from which information processors 12 may receive information for managing operation of machine 14 and/or any other machines that may form part of machine-management system 10.

Machine 14 may be any type of machine having a power train 18 for transmitting mechanical power to perform one or more tasks. Power train 18 may include any component or components configured to mechanically transmit power to a load, including, but not limited to, engines, motors, driveshafts, gears, chains, sprockets, belts, pulleys, couplers, clutches, and torque converters. As FIG. 1 shows, machine 14 may be a mobile machine, and power train 18 may be configured to propel machine 14. Power train 18 may include, for example, an engine 20 connected to a propulsion device 22 by a driveshaft 24, a transmission 26, and a final drive assembly 28. Propulsion device 22 may be a wheel, a track unit, or any other component suitable for propelling machine 14 with power received from the other components of power train 18.

Information processors 12 of machine-management system 10 may include any type of information-processing device(s) configured to receive information related to the operation of machine 14 and perform one or more tasks related to the operation of machine 14. Information processors 12 may include, for example, one or more computers programmed to perform various machine-management tasks based on information received about machine 14. One or more of information processors 12 may be mounted to machine 14. For example, one of information processors 12 may be a power train control module (PCM) 30 mounted to machine 14. Additionally, or alternatively, one or more of information processors 12 may be located off-board machine 14. For example, one of information processors 12 may be a remote computer terminal 32.

PCM 30 may monitor and/or control various aspects of the operation of power train 18. For example, in response to inputs from an operator, PCM 30 may control whether and how power train 18 propels machine 14 by monitoring and controlling the operating speed and power output of engine 20, as well as the operating state of transmission 26 and final drive assembly 28.

To enable PCM 30 to perform such tasks, the inputs 16 of machine-management system 10 may include various components and/or systems that provide PCM 30 with information regarding the manner in which the operator desires machine 14 to operate, as well as how machine 14 is operating. To provide information regarding how the operator desires machine 14 to operate, inputs 16 may include, for example, an operator interface 34 operatively connected to PCM 30, such as by a communication line 36. Operator interface 34 may include various components operable by the operator to communicate to PCM 30 various aspects of how the operator desires machine 14 to operate. For example, operator interface 34 may include a direction selector 44 for communicating whether the operator desires propulsion of machine 14 and, if so, in what direction (i.e., forward or reverse). Similarly, operator interface 34 may include a speed selector 46 for use by the operator to communicate how fast the operator desires power train 18 to propel machine 14.

Operator interface 34 may also include one or more provisions for providing information back to the operator. For example, operator interface 34 may have various conventional gauges and indicators, including, but not limited to, a speedometer, a tachometer, an hourmeter, pressure and temperature gauges, and warning lights. In some embodiments, operator interface 34 may also include other provisions for communicating with the operator, such as a graphical user interface 48, which may be operable to convey various information related to machine 14.

To provide information regarding the actual operating state of various components of power train 18, inputs 16 may include various sensors, component controllers, and/or other sources of information operatively connected to PCM 30, such as by communication lines 38, 40, and 42. From such sources, PCM 30 may receive a variety of information regarding the operation of power train 18, including, but not limited to, the speed of engine 20, information regarding the amount and timing of fuel delivery for engine 20, the direction and ratio of power transfer provided by transmission 26 and final drive assembly 28, one or more component speeds other than the engine speed, various temperatures and pressures in power train 18, and/or the position or operating state of various components like actuators and/or valves in power train 18.

Remote computer terminal 32 may be located in various places and operated by various entities to perform management of various aspects of the operation and/or maintenance of machine 14. In some embodiments, remote computer terminal 32 may be a site-management computer located at a worksite, such as a mine or other excavation site, of the owner of machine 14. In other embodiments, remote computer terminal 32 may be owned and operated by the owner of machine 14 but maintained remote from the owner's worksite, such as at an offsite management facility. In some embodiments, remote computer terminal 32 may be owned and operated by an entity other than the owner of machine 14. For example, remote computer terminal 32 may be owned and operated by the entity that manufactured machine 14 or by an entity contracted by the owner to maintain machine 14.

Remote computer terminal 32 may be operable to perform various machine-management tasks related to the operation of machine 14 and/or other machines. For example, remote computer terminal 32 may be used to monitor, and in some cases record, various aspects of the operation of machine 14, including, but not limited to, operating parameters of power train 18, operating parameters of other systems of machine 14, the location of machine 14 at various times, and the type of work performed by machine 14 at various times. Remote computer terminal 32 may also be used to monitor and/or record similar information related to other machines. Additionally, remote computer terminal 32 may also be used to track information related to the history of service procedures performed on machine 14 and/or other machines. Such tracked service information may include, for example, information regarding inspection procedures, lubrication procedures, component-replacement procedures, rebuilding procedures, and other service procedures performed on machine 14 and/or other machines. Using one or more of the foregoing types of information that remote computer terminal 32 may be used to monitor and/or track related to machine 14 and/or other machines, remote computer terminal 32 may be used to analyze and/or manage various aspects of the operation of machine 14 and/or other machines, as discussed in more detail below.

To enable remote computer terminal 32 to monitor, track, and manage various aspects of the operation of machine 14, the inputs 16 of machine-management system 10 may include various components and/or systems that provide information to remote computer terminal 32 regarding one or more aspects of the operation of machine 14. For example, inputs 16 may include a communication link 50 between remote computer terminal 32 and machine 14, such as a wireless communication link. Communication link 50 may be operable to transmit any information accessible by the controls of machine 14, such as PCM 30, to remote computer terminal 32. Such information may include, for example, information related to current and/or historical values of various operating parameters of power train 18. Such information may also include various other information related to the operation of machine 14. For example, in some embodiments, inputs 16 may include a global positioning system (GPS) module 52 operable to determine a position of machine 14, and communication link 50 may communicate the determined location of machine 14 to remote computer terminal 32.

Among other machine-management functions, machine-management system 10 may be configured to acquire information related to the loads and/or operating conditions experienced by one or more components of power train 18 during operation of machine 14. For example, machine-management system 10 may have provisions for acquiring information related to the loads experienced by driveshaft 24 during operation of machine 14. Such provisions may include, for instance, a sensor 56 configured to sense one or more loads experienced by driveshaft 24. In some embodiments, sensor 56 may have a configuration that allows it to sense the torque applied to driveshaft 24. Sensor 56 may have various configurations that allow it to sense a torque applied to driveshaft 24. In some embodiments, sensor 56 may sense the torque applied to driveshaft 24 without contacting driveshaft 24. In other embodiments, sensor 56 may be a type of sensor that senses torque applied to driveshaft 24 via contact with driveshaft 24, such as a strain gauge or the like. PCM 30 may receive signals from sensor 56 indicating the torque applied to driveshaft 24 via a communication line 58 or other communication means.

In addition to provisions for sensing the torque applied to driveshaft 24, machine-management system 10 may include provisions for sensing other aspects of the operation of driveshaft 24. For example, machine-management system 10 may have provisions for determining the speed of driveshaft 24. In some embodiments, sensor 56 may sense both the torque applied to driveshaft 24 and the speed (e.g., the rotational speed) of driveshaft 24, with or without contacting driveshaft 24. In other embodiments, machine-management system 10 may include one or more other sensors, in addition to sensor 56, for sensing the speed of driveshaft 24 and/or other aspects of the operation of driveshaft 24.

In addition to determining the loads and/or operating conditions experienced by driveshaft 24, machine-management system 10 may determine the loads and/or operating conditions experienced by other components of power-train 18. For example, PCM 30 may have provisions for determining the torque load and/or operating speeds of other components of power train 18 based on the sensed torque load and/or operating speed of driveshaft 24. PCM 30 may do so, for instance, using known information regarding drive ratios in power train 18. Such other components may be any kind of power train component, including, but not limited to, gears, shafts, sprockets, chains, couplers, clutches, bearings, and bushings.

Machine-management system 10 may also include provisions that facilitate tracking and using the history of loads experienced by a component of power train 18 over the whole life of the component. For example, machine-management system 10 may include a unique identifier 60 attached to driveshaft 24. Unique identifier 60 may be any feature that allows positively distinguishing driveshaft 24 from other components, including other components having the same part number and/or design. For example, unique identifier 60 may be a radio-frequency identification (RFID) tag with a signature or code unique to driveshaft 24. Alternatively, unique identifier 60 may be another type of electronic, magnetic, or optical identification component with a signature, code, or the like that is unique to driveshaft 24. Unique identifier 60 may also be a simple visual identifier, such as a label with a unique number or other type of identification attached to driveshaft 24. As discussed in more detail below, the inclusion of unique identifier 60 on driveshaft 24 may facilitate tracking the history of loads applied to driveshaft 24 in circumstances where driveshaft 24 is disassembled from power train 18 and subsequently reused.

Machine-management system 10 and its operation are not limited to the configuration shown in FIG. 1 and the examples discussed above. For example, machine-management system 10 may have provisions for tracking the history of loads applied to one or more other components of power train 18 in addition to, or instead of, provisions for tracking the history of loads applied to driveshaft 24. In such embodiments, machine-management system 10 may include a unique identifier like unique identifier 60 on each of the other tracked component(s), as well as one or more sensors for tracking the history of loads applied to each of the one or more other component(s). Additionally, machine-management system 10 may acquire information related to the history of loads applied to driveshaft 24 and/or other component(s) of power train 18 without employing any sensors to directly sense such loads. Machine-management system 10 may do so, for instance, by estimating the torque load on a component through knowledge of an estimated torque output of engine 20 and active drive ratios of transmission 26 and final drive assembly 28.

Additionally, the number, configuration, and interaction of information processors 12 and inputs 16 of machine-management system 10 may differ from the examples discussed above. In some embodiments, machine 14 may include one or more other information processors 12 in addition to, or instead of, PCM 30 to monitor the history of loads applied to driveshaft 24 and/or other components of power train 18. Additionally, machine-management system 10 may have provisions for transmitting information regarding the loads applied to driveshaft 24 and/or other components of power train 18 directly to remote computer terminal 32. For example, machine 14 may have a transmitter for transmitting sensor signals from sensor 56 directly to remote computer terminal 32.

Furthermore, in some embodiments, the information processors 12 of machine-management system 10 may include one or more other remote computer terminals, in addition to remote computer terminal 32. Any such other remote computer terminals may be operated at various locations by various entities, including, but not limited to, the above-discussed entities and locations. Any such other remote computer terminals may be networked with one another, remote computer terminal 32, and machine 14 to allow them to perform one or more of the same functions that remote computer terminal 32 may perform. In some embodiments, machine-management system 10 may employ multiple remote computer terminals networked together and operating collaboratively to perform one or more machine-management tasks.

Moreover, machine 14 and power train 18 may have different configurations than shown in FIG. 1. For example, power train 18 may omit one or more of engine 20, propulsion device 22, driveshaft 24, transmission 26, final drive assembly 28. Power train 18 may also include other components in addition to those shown in FIG. 1. Additionally, machine 14 may be a type of machine other than a mobile machine, and power train 18 may serve a different purpose than providing propulsion. Machine 14 may, for instance, be a stationary machine that uses power train 18 to perform any of various tasks.

### INDUSTRIAL APPLICABILITY

Machine-management system 10 may have use in any application where the ability to track the history of loads applied to a power-train component may prove beneficial. As mentioned above, over the course of its life, a power-train component such as driveshaft 24 may see use in multiple distinct periods. After its assembly to a power train, such a component may remain assembled to and serve in the power train for a first period.

Marking the end of the first period, it may be decided to disassemble the power-train component from the power train for various reasons. For example, due to degradation of various components of the power train, it may be decided to temporarily or permanently take the power train as it was initially assembled out of service. When this happens, an individual component of the power train, such as driveshaft 24, may have useful life remaining and may be reused in various ways. For example, such a component may be reused in a process of rebuilding or repairing the power train it was originally installed to, or in rebuilding or repairing another power train. In such a process, the power-train component may be again assembled to a power train (either the power train it was originally assembled to or another power train). In some cases, such a process may also involve refurbishment of the power-train component itself before it is again assembled to a power train. Such refurbishment may include, but is not limited to, rebuilding wear surfaces by welding and remachining them, and heat-treating the power-train component. After the power-train component is again installed to a power train, it may serve in that power train for a second period.

The process of using the power-train component in a power train, disassembling the power-train component from the power train, and reassembling the power-train component to the same or another power train and reusing the power-train component may be repeated any number of times. Indeed, for purposes of this disclosure, the “first period” may begin with the initial manufacture of the power train and the power-train component, or the “first period” may begin after the power-train component has already been used in a power train, disassembled from that power train, and then again assembled to the same or another power train for reuse.

The disclosed machine-management system 10 may allow tracking the load history of a power-train component during the first period of its use and any reuse that may occur thereafter. By way of example, machine-management system 10 may allow tracking the history of loads applied to and/or other operating conditions experienced by driveshaft 24 in the following manner. During the first period of use for driveshaft 24, information processors 12 may receive and store information from inputs 16 related to the loads applied to and/or other operating conditions experienced by driveshaft 24. For example, PCM 30 may receive signals from sensor 56 indicating the torque applied to and the operating speeds experienced by driveshaft 24.

PCM 30 may store a history of the signals from sensor 56 over time to provide a history of the torque loads applied to and operating speeds experienced by driveshaft 24 over time. PCM 30 may also estimate the number of cycles that driveshaft 24 experienced at each stored historical torque-load value by using various other information about the operation of power train 18 at the time each torque-load value was recorded. For example, PCM 30 may use the sensed operating speed of driveshaft 24 and/or information about the operating speed of the engine 20 and the active drive ratios of transmission 26 and final drive assembly 28 in combination with the stored torque-load values to determine the number of cycles driveshaft 24 experienced at each stored torque load. PCM 30 may transmit such information to remote computer terminal 32 via communication link 50.

Information processors 12 may use the stored information about the history of loads applied to and/or other operating conditions experienced by driveshaft 24 to estimate a remaining service life of driveshaft 24. For example, PCM 30 may use algorithms related to expected fatigue life of driveshaft 24 and the stored history of loads and/or other operating conditions to calculate an estimate that indicates the amount of service driveshaft 24 has remaining before failure. PCM 30 may estimate a percentage of the fatigue life of driveshaft 24 that has been used or remains. Additionally, or alternatively, PCM 30 may produce other estimates of the remaining service life of sensed component 54, such as an estimate of the remaining number of hours of service driveshaft 24 can provide before failing. PCM 30 may transmit the estimated remaining service life of driveshaft to remote computer terminal 32. Alternatively, PCM 30 may forgo estimating the remaining service life of driveshaft 24 and transmit to remote computer terminal 32 only raw data related to the loads that driveshaft has experienced. In some such embodiments, remote computer terminal 32 may use the information related to the history of loads experienced by driveshaft 24 to estimate a remaining service life of driveshaft 24.

As driveshaft 24 accumulates more service, information processors 12 may repeatedly update the estimated remaining service life of driveshaft 24. Additionally, information processors 12 may store a history of the estimated remaining service life of driveshaft 24. Information processors 12 may use such a history in various ways. For example, information processors 12 may refer to the manner in which the estimated remaining service life of driveshaft 24 has changed over time to refine the process for estimating the remaining service life of driveshaft 24.

Information processors 12 may associate the stored information regarding the history of torque loads and/or the estimated remaining service life of driveshaft 24 with the code or signature embodied by unique identifier 60. This may allow tracking the history of loads applied to driveshaft 24 and its estimated remaining service life over the whole life of driveshaft 24, including after disassembly of driveshaft 24 from power train 18 at the end of the first period of service of driveshaft 24. With the load history and/or estimated remaining service life associated to the code or signature embodied by unique identifier 60 attached to driveshaft 24, one may easily find this information for driveshaft 24, regardless of where driveshaft 24 may be. To do so, one need only read the code or signature embodied by unique identifier 60 and use that code or signature to retrieve from information processors 12 the associated information regarding the history of loads applied to driveshaft 24 and/or the estimated remaining service life of driveshaft 24.

The stored information related to the history of loads applied to driveshaft 24 and/or the estimated remaining service life of driveshaft 24 may be used in various ways over the course of the life of driveshaft 24. For example, after driveshaft 24 has been disassembled from power train 18 after the first period of use, one may use the information related to the history of loads applied to driveshaft 24 and/or the estimated remaining service life to evaluate whether the condition of driveshaft 24 warrants reusing driveshaft 24, or if driveshaft 24 should be scrapped. If it is decided to reuse driveshaft 24, the information related to the history of loads applied to it and/or the remaining service life may be used in deciding how to reuse the component. For example, this information may be used to determine whether to perform refurbishment procedures on driveshaft 24 or to simply reuse driveshaft 24 as is. Additionally, this information may be used by an entity that rebuilds power trains to decide whether to use driveshaft 24 to rebuild a power train or to sell driveshaft 24 to another entity for use in repairing or rebuilding a power train.

If an entity that rebuilds power trains in quantity decides to reuse driveshaft 24 in its process of rebuilding power trains, that entity may use the information related to the load history and/or estimated remaining service life of driveshaft 24 in various ways in its process of rebuilding power trains. For example, such an entity may match driveshaft 24 with other power-train components that have a similar amount of service life remaining. Doing so may help use the remaining service life of the power-train components more efficiently by tending to allow full use of the remaining service life of each of the components before additional service of the power train as a whole is required.

If an entity decides to resell driveshaft 24, the information regarding the load history and/or estimated remaining service life of driveshaft 24 may be used in various ways in connection with the sale. For example, the seller may set the price of the driveshaft 24 based at least in part on the load history and/or estimated remaining service life of driveshaft 24. Additionally, the load history or the estimated remaining service life of driveshaft 24 may be communicated to the buyer of driveshaft 24. The seller may also guarantee driveshaft 24 for a certain period of service based on the load history and/or estimated remaining service life.

Once driveshaft 24 is again assembled to a power train, machine-management system 10 may be used to perform various tasks based at least in part on the history of loads applied to driveshaft 24 during the first period of use prior to its disassembly from power train 18. To enable doing so, the load history of driveshaft 24 and/or the current estimated remaining service life of driveshaft 24 may be loaded in one or more of information processors 12. For example, in instances where driveshaft 24 is reinstalled in power train 18 of machine 14 and/or instances where driveshaft 24 is installed in another example of a machine with the same configuration as machine 14, the load history and/or remaining service life of driveshaft 24 may be updated or loaded in PCM 30. In instances where driveshaft 24 is assembled to a power train of a machine that does not include PCM 30, the load history and/or remaining service life of driveshaft 24 may be loaded in one or more other information processors of machine-management system 10. For example, the load history may be loaded on other information processors of the machine to which driveshaft 24 has been assembled. In either case, the load history and/or remaining service life of driveshaft 24 may be updated or loaded in remote computer terminal 32 and/or other remote computer terminals.

With driveshaft 24 again assembled to a power train, machine-management system 10 may resume tracking the loads applied to driveshaft 24. For example, in instances where driveshaft 24 is assembled to machine 14 or a machine having the same configuration as machine 14, PCM 30 may resume collecting information regarding the torque loads experienced by driveshaft 24 from sensor 56 and/or other sources of such information. Based on this information, machine-management system 10 may also resume repeatedly recalculating the estimated service life of driveshaft 24 remaining based on the loads applied to driveshaft 24 after it has been again assembled to the power train, in addition to the loads experienced by driveshaft 24 during its first period of service before it was disassembled from power train 18. As discussed before, this process may be performed with PCM 30, remote computer terminal 32, and/or any other information processors of machine-management system 10.

During the second period of service of driveshaft 24 after it has been again assembled to a power train, machine-management system 10 may be used to perform various other machine-management tasks based on the updated information regarding the history of loads applied to driveshaft 24 and/or the estimated remaining service life of driveshaft 24. For example, machine-management system 10 may be used to communicate the estimated remaining service life of driveshaft 24 to an operator of machine 14 via graphical user interface 48 and/or other communication devices. Similarly, machine-management system 10 may be used to communicate the estimated remaining service life of driveshaft 24 to other entities through communication devices mounted to machine 14 and/or other communication devices, such as remote computer terminal 32.

The machine-management tasks performed based on the updated estimated remaining service life of driveshaft 24 may also include various planning processes. For example, the estimated remaining service life of driveshaft 24 may be used to plan routine maintenance or to predict any need for major repairs. Additionally, the information related to the estimated remaining service life of driveshaft 24 may be used to plan operation of machine 14. For example, if the estimated remaining life of driveshaft 24 is higher than similar components in other machines used at a worksite, machine 14 may be used to perform more demanding tasks than those performed by other machines. On the other hand, if the estimated remaining service life of driveshaft 24 is relatively less than similar components of other machines at the worksite, machine 14 may be used to perform relatively less demanding tasks than other machines at the worksite.

Any of the above uses of the information regarding the history of loads applied to driveshaft 24 and/or the remaining service life of driveshaft 24 may account for any refurbishment of driveshaft 24 that occurs after its disassembly from power train 18 at the end of its first period of service. This may involve recalculating the estimated remaining service life of driveshaft 24 based at least in part on the effects of any refurbishment procedures before using the estimated remaining service life in the processes of rebuilding or repairing a machine with driveshaft 24, reselling driveshaft 24, and/or tracking the ongoing load history of driveshaft 24 after it is again assembled to a power train. For example, if driveshaft 24 is used to rebuild power train 18 or a power train of a machine that includes the same features as machine 14, the estimated remaining service life for driveshaft 24 that is loaded into PCM 30 may be calculated to account for any additional service life driveshaft 24 may be expected to have as a result of any refurbishment procedures performed on driveshaft 24 prior to it being again assembled to the power train.

Use of machine-management system 10 to track the load history and/or estimated remaining service life of a power-train component across its life is not limited to the examples discussed above. For instance, machine-management system 10 may be used to track the load history and/or estimated remaining service life of other power-train components in addition to, or instead of, driveshaft 24. In doing so, machine-management system 10 may use directly sensed information regarding the loads and/or other operating conditions experienced by such other components, and/or machine-management system 10 may determine some information regarding the loads and/or other operating conditions experienced by such other components indirectly by using information like known drive ratios and operating speeds of other components in power train 18.

Additionally, different methods and/or components may be used to perform the tracking and/or other machine-management functions discussed above. For example, rather than using sensor 56 and/or other sensors to directly sense operating conditions experienced by a power-train component, such as the loads applied to the power-train component and the operating speeds experienced by the power-train component, machine-management system 10 may indirectly estimate such operating conditions experienced by a power-train component using other information. Such other information may include, for instance, engine operating speed and torque output in combination with power-train drive ratios. Furthermore, in addition to, or instead of, torque loads applied to a power-train component, machine-management system 10 may monitor various other loads, such as compressive loads, tensile loads, thermal loads, and/or any other loads that may affect the service life of the power-train component. Moreover, the various tasks performed by machine-management system 10 may be distributed among the information processors 12 of machine-management system 10 in various ways other than the examples discussed above.

By allowing tracking the history of loads applied to a power-train component beyond its disassembly from a power train after its first period of use, the disclosed machine-management system 10 may allow better utilization of a power-train component from that point forward. The system may facilitate better decisions regarding whether and how to best reuse the power-train component. Additionally, the system may allow more informed management of the operation and maintenance of any machine into which the power-train component is assembled for reuse.

It will be apparent to those skilled in the art that various modifications and variations can be made in the disclosed machine-management system without departing from the scope of the disclosure. Other embodiments of the disclosed machine-management system will be apparent to those skilled in the art from consideration of the specification and practice of the machine-management system disclosed herein. It is intended that the specification and examples be considered as exemplary only, with a true scope of the disclosure being indicated by the following claims and their equivalents.

What is claimed is:

1. A method of using information related to the service history of a power-train component, comprising:
using a machine-management system with at least one information processor to acquire information related to loads experienced by the power-train component during a first period, the first period occurring before a disassembly procedure involving disassembly of the power-train component from a power train; and
employing the machine-management system and the acquired information related to loads experienced by the power-train component during the first period to perform one or more tasks in connection with use of the power-train component after the disassembly procedure.

2. The method of claim 1, wherein employing the machine-management system and the acquired information related to loads experienced by the power-train component during the first period to perform one or more tasks in connection with use of the power-train component after the disassembly procedure includes using the machine-management system to estimate a remaining service life of the power-train component based at least in part on the information related to loads experienced during the first period.

3. The method of claim 2, further comprising:
using the machine-management system to acquire information related to loads experienced by the power-train component during a second period, the second period occurring after the disassembly procedure and a subsequent assembly procedure in which the power-train component is again assembled to a power train of a machine; and
wherein using the machine-management system to estimate a remaining service life of the power-train component includes estimating the remaining service life of the power-train component based at least in part on the information related to loads experienced by the power-train component during the second period, in addition to loads experienced by the power-train component during the first period.

4. The method of claim 3, wherein using the machine-management system to estimate the remaining service life of the power-train component further includes accounting for refurbishment of the power-train component that occurs between the disassembly procedure and the assembly procedure.

5. The method of claim 2, further comprising:
selling the power-train component as a used power-train component; and
providing the estimated remaining service life of the power-train component to a buyer of the power-train component.

6. The method of claim 1, wherein employing the machine-management system and the acquired information related to loads experienced by the power-train component during the first period to perform one or more tasks in connection with use of the power-train component after the disassembly procedure includes using an RFID tag attached to the power-train component to identify the power-train component and facilitate tracking the information related to loads experienced by the power-train component during the first period.

7. The method of claim 1, further comprising after the disassembly procedure and a subsequent assembly procedure in which the power-train component is again assembled to a power train of a machine, using the machine-management system to plan use of the machine based at least in part on the acquired information related to the loads experienced by the machine during the first period.

8. The method of claim 1, further comprising:
after the disassembly procedure, using the power-train component in a process of rebuilding one or more power trains; and
wherein employing the machine-management system and the acquired information related to loads experienced by the power-train component during the first period to perform one or more tasks in connection with use of the power-train component after the disassembly procedure includes performing the rebuilding process based at least in part on the acquired information related to loads experienced by the power-train component during the first period.

9. The method of claim 1, wherein the power-train component is a component of a power train of a mobile machine.

10. The method of claim 1, wherein the power-train component is a component of a final drive assembly of a mobile machine.

11. The method of claim 1, wherein using the machine-management system to acquire information related to loads experienced by the power-train component during the first period includes acquiring sensor information indicative of torque loads experienced by the power-train component during the first period.

12. A machine-management system, comprising:
a machine having a power train, the power train including a power-train component that was assembled to the power train in a service procedure after the power-train component had been used during a prior period; and
at least one information processor that performs one or more machine-management tasks based at least in part on information related to loads experienced by the power-train component before its assembly to the power train in the service procedure.

13. The machine-management system of claim 12, wherein the one or more machine-management tasks performed by the at least one information processor include estimation of a remaining service life of the power-train component based at least in part on the information related to loads experienced by the power-train component before its assembly to the power train in the service procedure.

14. The machine-management system of claim 13, wherein:
the at least one information processor also receives information related to loads experienced by the power-train component after its assembly to the power train in the service procedure; and
the estimation of the remaining service life of the power-train component is based on the acquired information related to loads experienced by the power-train component after its assembly to the power train in the service procedure, in addition to the information related to loads experienced by the power-train component before its assembly to the power train in the service procedure.

15. The machine-management system of claim 14, wherein the estimation of the remaining service life of the power-train component also accounts for any refurbishment of the power-train component prior to its assembly to the power train in the service procedure.

16. The machine-management system of claim 12, wherein the one or more machine-management tasks performed by the at least one information processor include planning use of the machine based at least in part on the information related to loads experienced by the power-train component before its assembly to the power train in the service procedure.

17. The machine-management system of claim 12, wherein:
the machine is a mobile machine; and
the information related to loads experienced by the power-train component before its assembly to the power train in the service procedure includes sensor information indicative of torque loads experienced by the power-train component prior to its assembly to the power train in the service procedure.

18. The machine-management system of claim 12, further comprising an RFID tag attached to the power-train component for identifying the power-train component and facilitating tracking of the information related to loads experienced by the power-train component before its assembly to the power train in the service procedure

19. A method of operating a mobile machine, comprising:
transmitting torque through a power train to propel the mobile machine, including transmitting torque through a power-train component that was assembled to the power train during a service procedure after having been used to transmit torque during a prior period;
sensing a magnitude of the torque transmitted through the power-train component subsequent to the service procedure; and
estimating a remaining service life of the power-train component based on the sensed value of the torque transmitted through the power-train component subsequent to the service procedure in combination with information related to torque loads transmitted through the power-train component prior to the installation of the power-train component to the power train in the service procedure.

20. The method of claim 18, further comprising planning at least one of maintenance of the mobile machine and usage of the mobile machine based at least in part on the estimated remaining service life of the power-train component.
